(19) United States
(12) Patent Application Publication
(10) Pub. No.: US 2018/0331919 A1
(43) Pub. Date: Nov. 15, 2018

(54) Obtain network address of one or more network device for use in authentication

(71) Applicant: Martin Stuart Boyd, Sydney (AU)

(72) Inventor: Martin Stuart Boyd, Sydney (AU)

(21) Appl. No.: 15/951,173

(22) Filed: Apr. 12, 2018

Related U.S. Application Data
(60) Provisional application No. 62/503,941, filed on May 10, 2017.

(51) Int. Cl. H04L 12/24; H04L 29/06; H04L 29/12

(52) U.S. Cl. CPC H04L 41/28; H04L 61/20; H04L 63/029

(57) ABSTRACT

In one embodiment, the present invention relates to obtaining the network address of the network device such as an IP from a laptop, that it is stored in a system. This system then combines these IP addresses and IP address ranges from one or more network devices into groups. Each group has a list of these IP addresses and IP address ranges which can be downloaded and used within authentication device such as a firewall to only allow a specific group of laptops access to the network accessible resource such as a website or an email service.

### TECHNICAL FIELD

The present invention pertains generally to network communications and using network address for providing access

### BACKGROUND

Software and Hardware used within network devices have a history of having vulnerabilities that can allow the bypass or modification of the authentication on an authentication device. These vulnerabilities can then be used for malicious purposes.

The internet is a great opportunity to allow access to a network accessible resource as it can allow access from around the world. The problem is the internet has billions of users and network devices, some of which may have malicious intentions. Allowing access to all these users and network devices creates a risk.

A network device is any computing device that has the ability to communicate on the network. Some examples of network devices that apply to the internet include firewalls, applications gateways, switches, routers, load balancers, virtual servers, servers, desktops, laptops, end user devices, client systems, tablets, phones, raspberry pis, mobiles and Internet of Things (IOT).

A network accessible resource is a resource that is accessible over the network. Some examples of network accessible resources that apply to the internet include website, email, network device, network service, network program, authentication device, internet, secure shell (SSH), network, water pump controller, electrical power controller, Internet of Things (IOT), camera, server or even a network connected car.

An authentication device is a network device that performs authentication. This may be user and login based authentication or some other form of authentication. An example might be a firewall that allows access to a private network, a firewall that allows access to a network, a firewall that allows access to a network device, a website that allows access to a email or a server that allows access to a program on the server.

The subject matter claimed herein is not limited to embodiments that solve any disadvantages or that operate only in environments such as those described above.

Rather, this background is only provided to illustrate one exemplary technology area where some embodiments described herein may be practice.

### SUMMARY OF INVENTION

With many new vulnerabilities being found, it is not easy to protect a network accessible resource from vulnerabilities. Also with increasing sophistication of password theft a username and password may not be enough protection to confirm the authentication of a user.

Furthermore many network devices use a dynamic network address which may change and hence be difficult to know.

The present invention relates to obtaining the network address of a network device. Then the network address is obtained by the authentication device from the present invention for use in authentication.

In a particular embodiment, where the network devices are known, then only those network devices should be provided access to the network accessible resource. For example the authentication device would block most, if not all the unknown network devices from even connecting avoiding or reducing the risk of an unknown network device taking advantage of a vulnerability.

This summary is for the purposes of explanation and understanding; of the present invention. It should be appreciated, however, that the present invention may be practiced in a variety of ways beyond the specific details set within. Therefore, this summary is not to be taken in a limiting sense, and the scope of the present invention is defined only the appended claims and their equivalents.

### BRIEF DESCRIPTION OF DRAWINGS

FIG. 1 illustrates an example network connections of the present invention

FIG. 2 illustrates an example network flow of the present invention

### DESCRIPTION OF EMBODIMENTS

The invention will be described below in relation to an Internet Protocol (IP) connected network environment. Although well suited for use in IP connected networks, the invention is not limited to use with any particular type of communication system or configuration of system elements and those skilled in the art will recognise that the disclosed techniques may be used in any application in which it is desirable to provide authentication using one or more network addresses.

The exemplary systems and methods of this invention will be described in relation to software, modules, and associated hardware and network(s). However, to avoid unnecessarily obscuring the present invention, the following description admits well-known structures, components and devices that may be shown in block diagram form, are well known, or are otherwise summarised.

For purposes of explanation, numerous details are set forth in order to provide a thorough understanding of the present invention. It should be appreciated, however, that the present invention may be practiced in a variety of ways beyond the specific details set forth herein. The following description is, therefore, not to be taken in a limiting sense, and the scope of the present invention is defined only by the appended claims and their equivalents.

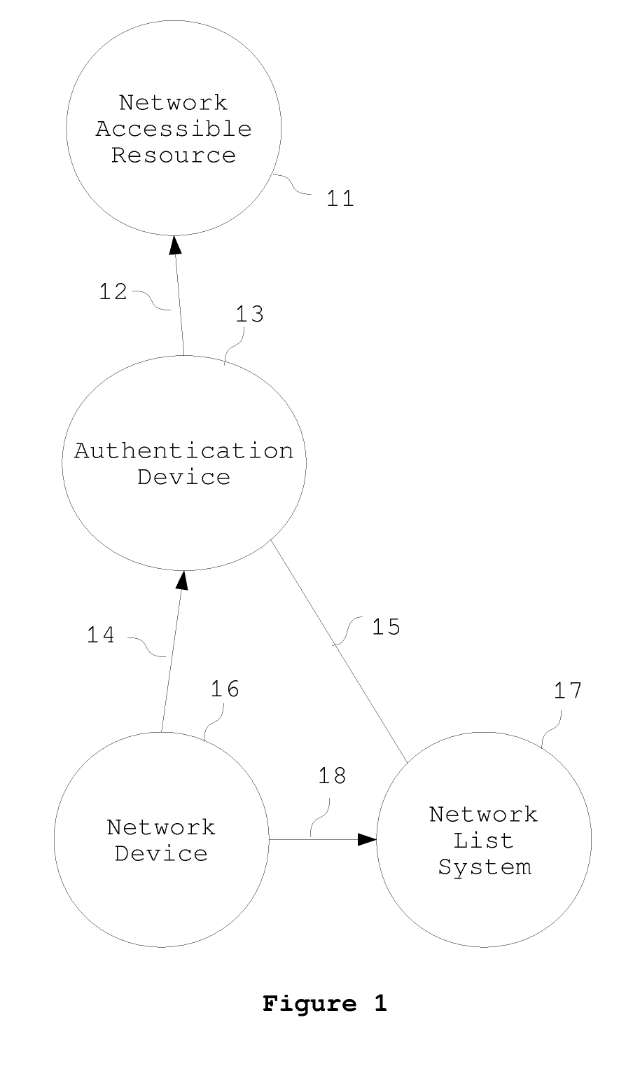

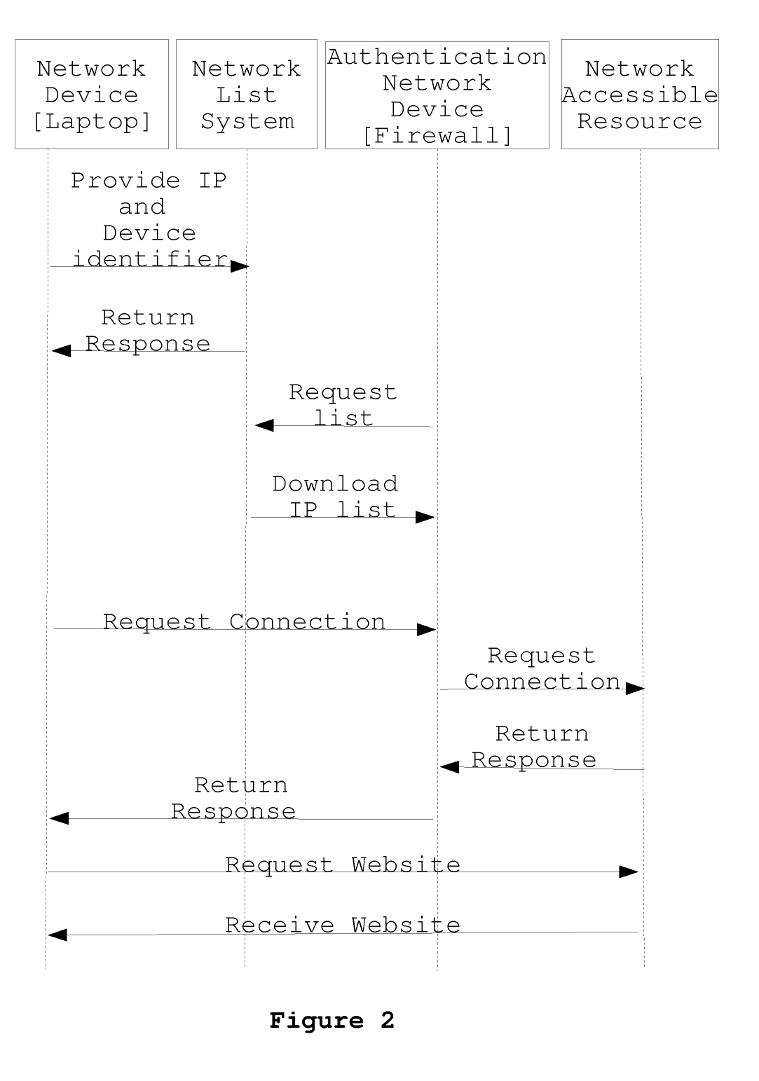

In an embodiment of the invention, an organisation would have software on all their laptops (network device FIG. 1-16). This software would report the IP address (network address) to a network list system (FIG. 1-17). The network list system would be configured to combine the organisation's laptops IP addresses into a single list with an unique identifier such as 123ABC. The organisation's firewall (authentication device FIG. 1-13) would download the list with the identifier 123ABC and only provide access to the IP addresses on the list. The firewall would download the list and update the access every 20 minutes to ensure its rules are up to date. In this example the firewall is controlling access to internal website for email (network accessible resource FIG. 1-11) and organisation's news (network accessible resource FIG. 1-11), allowing employees to be working away from the office but still have access to company resources. The email website may also require a username and password for access, but the news website is accessible without any further authentication. This also means any unknown network devices that are not on the list are blocked from connecting and hence unable to execute a vulnerability.

In another embodiment of the invention the list of IP addresses is used as a secondary authentication mechanism used by a bank website (network accessible resource FIG. 1-11 and authentication device FIG. 1-13) where the bank website will provide the user with the ability to configure the specific list identifier to be used from the network list system (FIG. 1-17). That way next time the user attempts to login with a username and password to the bank website, the bank website will use the specific user configured list identifier to download a list from the network list system. The bank website would then check the users network device (FIG. 1-16) IP address against the specific download list containing IP addresses and IP address ranges. If they match, and the username and password are correct then access is allowed (communication FIG. 1-14), otherwise access is denied.

In an embodiment of the invention an organisation may always want to be able to access their laptops (network device FIG. 1-16). So by placing software on the laptops that send the IP address to the network list system (FIG. 1-17), they are able to query the network list system and get the latest IP, and attempt a direct connection with the laptop.

A particular embodiment of the invention can also be used for specific computers known as Internet of Thing (IOT) (authentication device FIG. 1-13 and network accessible resource FIG. 1-11). To ensure only known computers (network device FIG. 1-16) have access to the IOT, it has a unique identifier which is used to get a list of IP addresses from the network list system (FIG. 1-17). The unique identifier is sufficiently complex that it is very difficult to guess. A user after they have purchased the IOT can then connect to the network list system, and using the unique identifier add their IP address to the list so they can access their IOT. This provides the advantage that IOT would by default not allow any access and reduce the ability for vulnerabilities to be used against IOTs.

In an embodiment of the invention an organisation may have expectations of their laptops (network device FIG. 1-16) having certain files or software such as antivirus before they can connect to the organisations network. By placing software on the laptops that send this information and the IP address to the network list system (FIG. 1-17). The network list system then applies configuration and matching rules on which IP addresses are shown in the list. This way the network list system can choose which IP addresses are shown by information provided by the laptop such as the date of the last IP address is less than one month old, if it matches a blocked IP, if the antivirus software is installed, if a certain version of file exists, if a registry configuration is set to 1, or if a file exists. Hence the network list system is able to filter the list to only IP addresses of those laptops that have antivirus running and are up to date. Therefore any laptop which has antivirus removed or is not up to date is not able to access the network. This is because the firewall (authentication device FIG. 1-13) controlling access to the network is downloading (FIG. 1-15) and using this list from the network list system for identifying who has access.

In another embodiment of the invention the network devices (FIG. 1-16) are mobile phones and they are identified by the network list system using encryption. The mobile phone would contain a private key which it would use to sign the messages, and the network list system would use a public key to confirm the identity of the mobile phone. Furthermore a hardware serial number would also be provided as another identifier to ensure the private key has not been copied to another device. Using this information the network list system (FIG. 1-17) would be able to store the IP address of the mobile phone with relationship to the specific mobile phone. Then an email server (network accessible resource FIG. 1-11 and authentication device FIG. 1-13) could download the list from the network list system and provide access to these mobile phones to send and receive emails.

In another embodiment of the invention the network list system (FIG. 1-17) is comprised of three servers. One within an organisations private network to receive connections (FIG. 1-18) for desktops (network device FIG. 1-16) from the private network. One within the internet to receive connections for the laptops on the internet and one server used for providing the lists. This way the network list system can provide internal private network and internet network IP address lists. As this organisation uses the firewall within the servers providing the website (authentication device FIG. 1-13 and network accessible resource FIG. 1-11) and email (authentication device FIG. 1-13 and network accessible resource FIG. 1-11), they are able to download and combine both lists for the internal private network and the internet network for use in providing access.

In an embodiment of the invention the network list system (FIG. 1-17) provides a list of commands or instructions that are interpreted or executed by an authentication device (FIG. 1-13). This way the authentication device which may not be able to use a list of IP addresses or IP network ranges can still perform some part of authentication after executing the commands.

1. A system of obtaining one or more network address of one or more network device for use in authentication comprising:
at least one processor;
storage for storing said network address along with other information, said other information including at least an identifier comprising a unique code that uniquely identifies said network device to said system;
communication means for said network device to communicate its one or more network address along with said other information to said system;
processing means to execute instructions on said processor to analyse said network address and said other information into at least one list containing either said network address, network range or any combination of said network address and network range;
wherein said network range including a network address range from at least one said network address;
communication means for said system to communicate said list to one or more authentication device wherein said authentication device uses said list for positive authorisation determination for providing access to either network, network accessible resource or any combination of network and network accessible resource;
wherein positive authorisation determination is made at least in part because a network address requesting authentication matches either network address, network range or any combination of network address and network range in said list.

2. A system according to any one of the preceding claims, wherein analysis of said network address and said other information includes one or more filtering rule to determine if said network address is allowed onto said list.

3. A system according to any one of the preceding claims, wherein contents of said list are rules or commands to be interpreted or executed on an authentication device.

4. A system according to any one of the preceding claims, wherein one or more said list also contains one or more manual entries of either network address, network range or any combination of network address and network range.

5. A system according to any one of the preceding claims, wherein encryption keys and signed messages are used in place of or with the said identifier.

6. A system according to any one of the preceding claims, wherein each said list has a unique code that uniquely identifies said list to said system.

7. A system according to any one of the preceding claims, wherein on obtaining the said network address and said other information from said network device based on a set of rules an action or command is performed.

8. A system according to any one of the preceding claims, wherein said list is any combination of network address and network range from more than one network device.

9. A system according to any one of the preceding claims, wherein the internet is used as said communication means.

10. A system according to any one of the preceding claims, wherein said positive authorisation is either positive authorisation, negative authorisation or any combination of positive authorisation and negative authorisation.

11. A method of obtaining one or more network address of one or more network device for the use in authentication comprising:
storing said network address along with other information, said other information including at least an identifier comprising a unique code that uniquely identifies said network device;
obtaining one or more network address of network device;
analysing said network address and said other information into at least one list containing either said network address, network range or any combination of said network address and network range;
wherein said network range including a network address range from at least one said network address;
obtaining said list to one or more authentication device wherein said authentication device uses said list for positive authorisation determination for providing access to either network, network accessible resource or any combination of network and network accessible resource;
wherein positive authorisation determination is made at least in part because the network address requesting authentication matches either network address, network range or any combination of network address and network range in said list.

12. A method according to claim 11, wherein the analysis of said network address and said other information includes one or more filtering rule to determine if said network address is allowed onto said list.

13. A method according to any one of claims 11 to 12, wherein the contents of said list are rules or commands to be interpreted or executed on authentication device.

14. A method according to any one of claims 11 to 13, wherein one or more said list also contains one or more manual entries of either network address, network range or any combination of network address and network range.

15. A method according to any one of claims 11 to 14, wherein on obtaining the said network address and said other information from said network device based on a set of rules an action or command is performed.

16. A method according to any one of claims 11 to 15, wherein encryption keys and signed messages are used in place of or with the said identifier.

17. A method according to any one of claims 11 to 16, wherein said list is any combination of network address and network range from more than one network device.

18. A method according to any one of claims 11 to 17, wherein said positive authorisation is either positive authorisation, negative authorisation or any combination of positive authorisation and negative authorisation.
